(19) United States
(12) Patent Application Publication
(10) Pub. No.: US 2013/0233689 A1
(43) Pub. Date: Sep. 12, 2013

(54) SEAMLESS FACEPLATE ASSEMBLY FOR KEYPAD DEVICE

(71) Applicant: Kian Ho Ng, Singapore (SG)

(72) Inventor: Kian Ho Ng, Singapore (SG)

(73) Assignee: KONINKLIJKE PHILIPS ELECTRONICS N.V., EINDHOVEN (NL)

(21) Appl. No.: 13/881,276

(22) PCT Filed: Nov. 3, 2011
(86) PCT No.: PCT/IB11/54878

§ 371 Date: Apr. 24, 2013

(30) Foreign Application Priority Data
Nov. 17, 2010 (EP) 10191455.4

(51) Int. Cl. H01H 13/86; H01H 13/88

(52) U.S. Cl. CPC H01H 13/86; H01H 13/88
USPC 200/5 A; 29/622

(57) ABSTRACT

An assembly (20) for use in a keypad device (10) and a corresponding keypad device (10) are described. The assembly (20) comprises a seamless faceplate (30) with a plurality of key areas protruding outwardly from a surface (32) of the faceplate. The key areas are made of slightly deformable material. The assembly further comprises a plurality of switch elements (e.g., dome switches) (62), which at least partly correspond to the key areas. The switch elements are arranged to contact a corresponding contact point on a circuit arrangement (90) e.g. a PCB, as a result of force on the corresponding key area being applied by a user, wherein after the user stops applying the force, the key area returns to its original position, e.g. due to the corresponding dome switch returning to its original position.

### FIELD OF THE INVENTION

The present invention relates to the field of keypad devices and more particularly to a faceplate assembly for use in a keypad device. Such a keypad device may for example be a remote control, a (mobile) telephone, a calculator, etc.

### BACKGROUND OF THE INVENTION

Keypad devices, such as remote controls are widely available. A classical example thereof is a remote control with individual plastic keys protruding from the housing, which keys can be pressed by the user. However, with such a design there need to be gaps between the keys and the housing for key movement purposes. As a result, the external appearance of such a remote control is not so appealing. Furthermore, it is not so resistant to liquids or humidity.

Another known remote control design uses a poly dome faceplate, which is pasted on the top housing. Indications of the remote control functionality can be printed on the faceplate. This plastic faceplate and the top housing act as a protector to the external environment, for example to liquids. However, in order to enable standard pressing by the user for all keys, i.e. pressing all keys with the same force, the keys need a standard size and shape. So, different key sizes and shapes are not possible with this type of design, because it would result in different activation forces for different keys.

A still further known remote control has a through-hole faceplate. The keys, which are arranged as a layer below the faceplate, further in this description referred to as keymat, protrude through the holes for pressing purposes. However, due to the holes and gaps between the keys and the faceplate this design, just as the remote control with individual plastic keys, is not so appealing. Furthermore, it suffers again from a lack of resistance to liquids.

A remote control design, which addresses some of these problems, is disclosed in US 2008/0271980 A1. Herein, a one body style keypad of thin dimensions is disclosed. A visually high-quality presentation is realized due to the inherent luster of synthetic resin. A key top, a base, and a front housing are formed into a self-contained single unit by the thin strip made of a synthetic resin member with respect to a one body style keypad. However, the upper surface of the keypad is completely flat, resulting in some difficulties for the user in identifying the key sections, particularly under bad light conditions. A solution to this problem would be to include backlighting in the remote control. However, this would make the remote control bigger, more expensive and it would increase the power being used and thereby shorten the battery life.

### SUMMARY OF THE INVENTION

It would be desirable to provide a seamless keypad design, wherein the user can easily identify the key sections. Furthermore, it would be desirable to provide a design allowing the use of a standard manufacturing and assembly method. The invention is defined by the independent claims. The dependent claims define advantageous embodiments.

To better address at least one of these concerns, according to an aspect of the invention an assembly for use in a keypad device is provided. The assembly comprises a seamless faceplate comprising a plurality of key areas protruding outwardly from a remainder of the surface of the faceplate, the key areas being of deformable material. As a result, three-dimensional (3D) keys are provided, each having a protrusion, shape and size. The keys can be easily found by the user, even in adverse light conditions. The assembly furthermore comprises a plurality of switch elements (e.g., dome switches), which at least partly correspond to the key areas. The switch elements are arranged to contact a corresponding contact point on a circuit arrangement, which may be a printed circuit board PCB, as a result of force being applied by a user on the corresponding key area. After the user stops applying the force on the key area, it returns to its original position, e.g. due to the corresponding dome switch returning to its original position (Alternatively, the key area could return to its original position, e.g., because the key-area is elastic).

As a result, a seamless faceplate assembly is provided with well defined, protruded 3D keys, thereby improving the key pressing. Furthermore, there are no obvious holes and gaps, rendering the design resistant to liquids and humidity and rendering the occurrence of Electrical Static Discharge (ESD) less likely. Still further, the seamless design may be compact, which will contribute to an attractive outlook with a smooth and slimmer curvature having reduced weight and height. Standard faceplate associated parts and standard productions methods can be used for the faceplate assembly and manufacturing, thereby reducing assembly and manufacturing costs. The overall remote costs may be reduced due to less material being used, which results additionally in reduced packaging and transport costs and reduced waste material production, thereby reducing environmental impact. A modular approach can alternatively be applied, wherein there is more than one integrated faceplate design for the same product. The different faceplates have different faceplate printings, colors, sizes and texture for better consumer appeal.

According to an embodiment of the present invention, the plurality of dome switches is arranged in a dome sheet. The dome sheet may be a poly dome sheet, for example of polyester or a metal dome sheet. Poly dome sheets generally have a lower cost and the dome switches push back the corresponding key areas sufficiently equally to give the user a consistent pressing feeling. Metal dome sheets give the user a crisp, positive tactile feedback when a key is pressed. Alternatively, the switch elements may be made of rubber, although such rubber switches have more variation in forces and therefore give the user a slightly less consistent pressing feeling. However, this option is more economical than the poly dome or metal dome sheet and therefore highly suitable for low end applications.

A first spacing sheet may be located between the faceplate and the dome sheet. This results in a strong structure, with an increased strength and rigidness of the faceplate. The first spacing sheet may be adhered to the faceplate, for example by means of an adhesive sheet, which is an economical way for adhering.

The assembly may furthermore comprise a second spacing sheet for separating the dome sheet and the PCB, resulting in a further increased strength of the structure.

The faceplate may be at least partially translucent or transparent. As a result, there may be complex printing and graphic options on the inner side of the faceplate, such as indications of the keypad functionality and even real life pictures. By printing the faceplate, there is no need to print other components. So, component costs may be further reduced. The faceplate may be made of polyester, which is a slightly deformable but strong material. It is furthermore possible to print the rough texture paint on the faceplate, externally thereby providing better user grip of the keypad device.

One of the following parameters of the key areas of the faceplate may be different between at least some of the key areas: size, shape or protrusion. By using mutually different key sizes, shapes and protrusions, the design may be made more appealing and users may recognize the differences between the keys quickly by touching. This is particularly useful in dim light conditions. Due to the assembly structure “standard” pressing for all keys may be provided, i.e. the pressing of the keys with the different sizes and shapes feels approximately the same to the user and also the force to be applied is roughly the same. The further parts of the PCB and the assembly defining the keys can be standard, only the 3D keys of the faceplate have different sizes, shapes and protrusions. So, product variations may be limited to the faceplate.

Additional layers like a special color sheet, light guides and an electroluminescent (EL) sheet, can be integrated into the assembly as needed. Although, as explained above this is not needed for the user to locate the keys, backlighting may be implemented by means of the electroluminescent sheet or by means of discrete LEDs located on the PCB between the contact points of the switch elements (e.g., dome switches). The special color sheet may filter the light, so that only red or blue light passes. Hereby, the keypad design is even more appealing to the user. In case of a backlighting design, the faceplate should have selected non-printed areas.

The faceplate may have a flap shape at its edges. This makes its assembly into the housing of the keypad easier as it serves as a guide. Furthermore, it results in reduced light leakage, in case that the keypad has backlighting.

According to a further aspect of the invention, a keypad device is provided comprising the assembly and furthermore the PCB, which acts as a support to the assembly. The keypad device may further comprise a top housing and a bottom housing. A part of the top housing at least partially surrounds the edge of the faceplate. Thereby, the exterior part of the faceplate is completely visible for a user. The top and bottom housing may be made of plastic.

The keypad device may further comprise a plurality of inner keys, each of the inner keys located between one of the key areas of the faceplate and one of the switch elements (e.g., dome switches). This is particularly advantageous if a metal dome sheet is used with dome switches. The inner keys, which are for example rubber keys act as a cushion to the key areas of the faceplate and form an intermediate layer, which in use, passes on the force from the key areas of the faceplate to the switch elements (dome switches) back and force. Furthermore, they cause a pleasant tactile feedback for the user. They also serve for damping in a part of the assembly. Damping is sometimes needed, because due to parts tolerance in a complex assembly, external excitations or vibrations with a high frequency can create different harmonic oscillations in mechanical parts, which become electrical ‘noise’.

A part of the top housing cover may be located between the plurality of inner keys, wherein the inner side of the faceplate, which does not correspond to the key areas thereof is supported by the top housing cover. As a result, a strong keypad structure is provided.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a perspective top view of a remote control with a seamless 3D key faceplate assembly according to a first embodiment of the invention;

FIG. 2 shows an exploded view of the components of the remote control according to FIG. 1;

FIG. 3 shows a perspective top view of the seamless 3D key faceplate of the remote control according to FIG. 1.

FIG. 4 shows a perspective top view of the seamless 3D key faceplate of the remote control according to FIG. 1.

FIG. 5 shows a bottom view of the seamless 3D key faceplate assembly according to the first embodiment.

FIG. 6 shows a cross sectional view in perspective of the remote control according to FIG. 1.

FIG. 7 shows a perspective top view of a remote control with a seamless 3D key faceplate assembly according to a second embodiment of the invention;

FIG. 8 shows an exploded view of the components of the remote control according to FIG. 7;

FIG. 9 shows a perspective top view of the seamless 3D key faceplate of the remote control according to FIG. 7.

FIG. 10 shows a perspective top view of the seamless 3D key faceplate of the remote control according to FIG. 7.

FIG. 11 shows a bottom view of the seamless 3D key faceplate assembly according to the second embodiment.

FIG. 12 shows a sectional, exploded view of the seamless 3D key faceplate assembly according to the second embodiment of the invention.

FIG. 13 shows a perspective top of the arrangement of LEDs and light guide with the seamless 3D key faceplate assembly according to the second embodiment of the invention.

Throughout the Figs. like reference numerals refer to like elements.

### DETAILED DESCRIPTION OF EMBODIMENTS OF THE PRESENT INVENTION

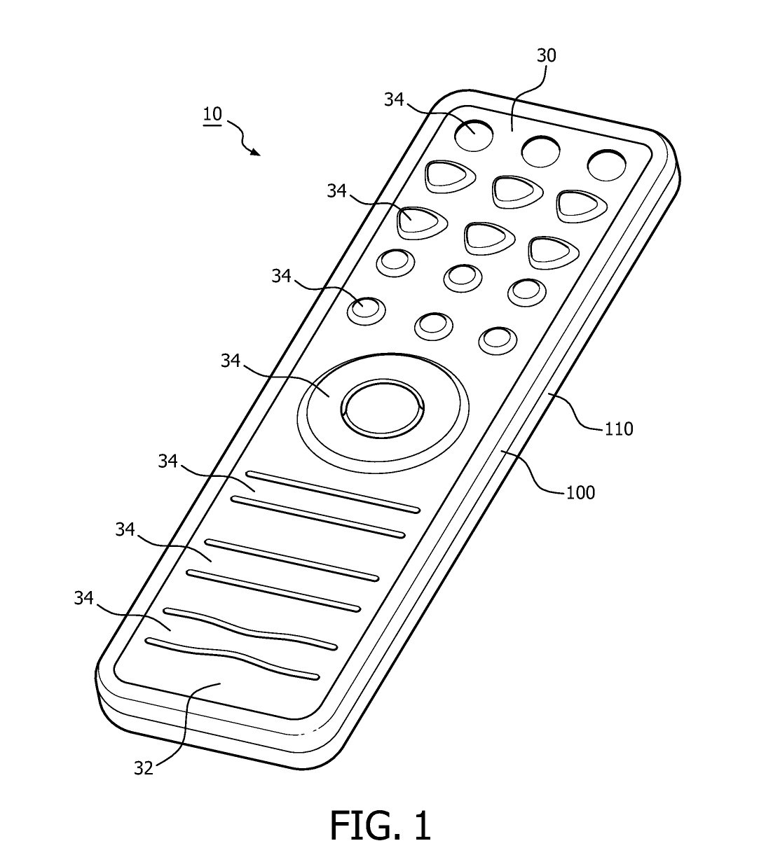

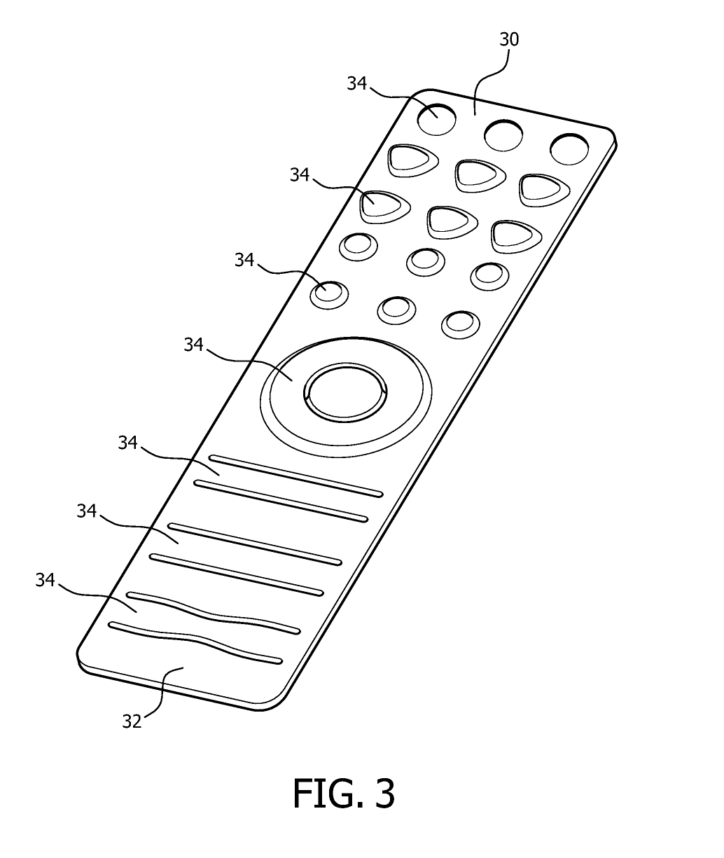

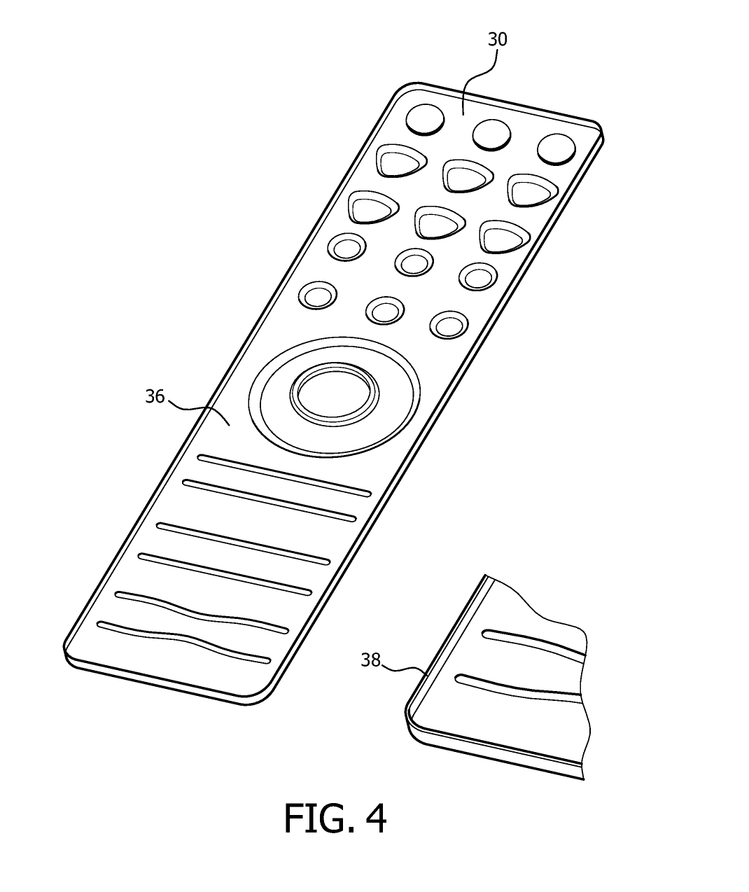

Referring to Figs. 1-6 a first exemplary embodiment of a keypad device according to the invention will be described. The key pad device 10, in this example a remote control, comprises an assembly 20, which may be manufactured separately from the remaining part 80 of the remote control. The assembly comprises a seamless translucent faceplate 30, shown in detail in FIGS. 3 and 4. The faceplate may be made of polyester. When the assembly is attached to the remainder of the remote control the faceplate becomes the top side of the remote control. The faceplate has a top side 32, with a plurality of key areas 34 of mutually different shapes protruding outwardly from a remainder of the surface of the top side 32. Each of the key areas 34 defines a 3D key. The key areas may differ in size, shape (round, diamond, etc.), as well as the protrusion/profile thereof (inclined or flat). The key areas 34 are slightly deformable. The keys are ‘formed’ in order to obtain the key area shapes. Additionally, some further protruding areas may be added for cosmetic purposes, such as a logo or a styling groove in order to give the top surface of the keypad device a 3D effect. The faceplate may be printed with options on the inner (reverse) side 36 of the faceplate including the key areas 32, such as indications of the keypad functionality. The edge 38 of the faceplate has a flap shape.

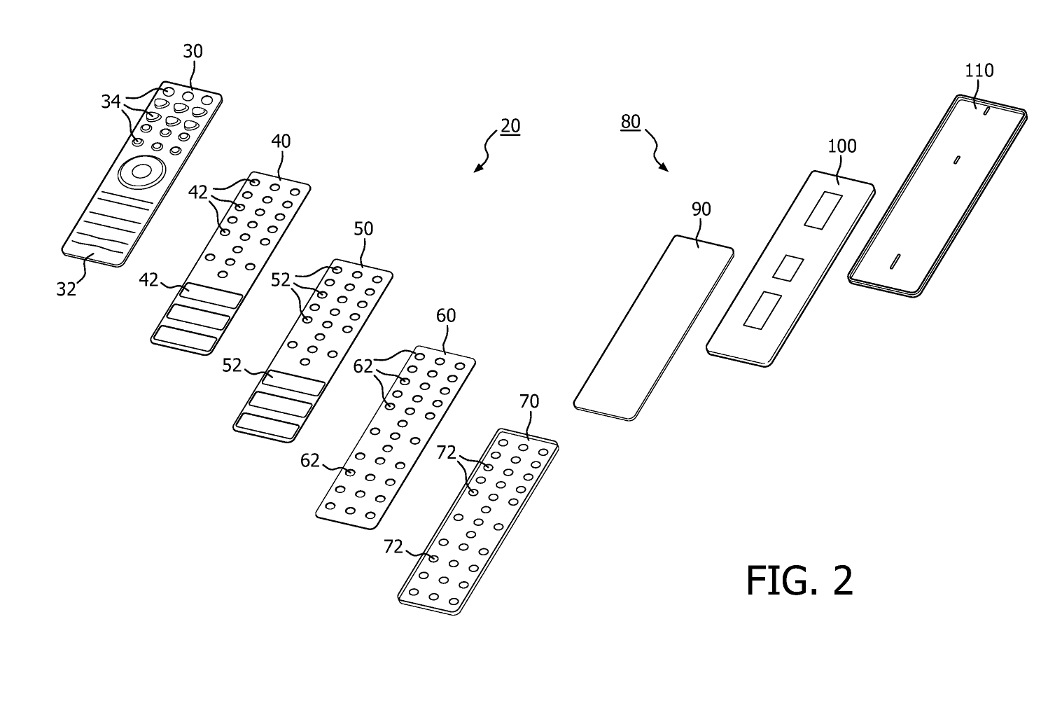

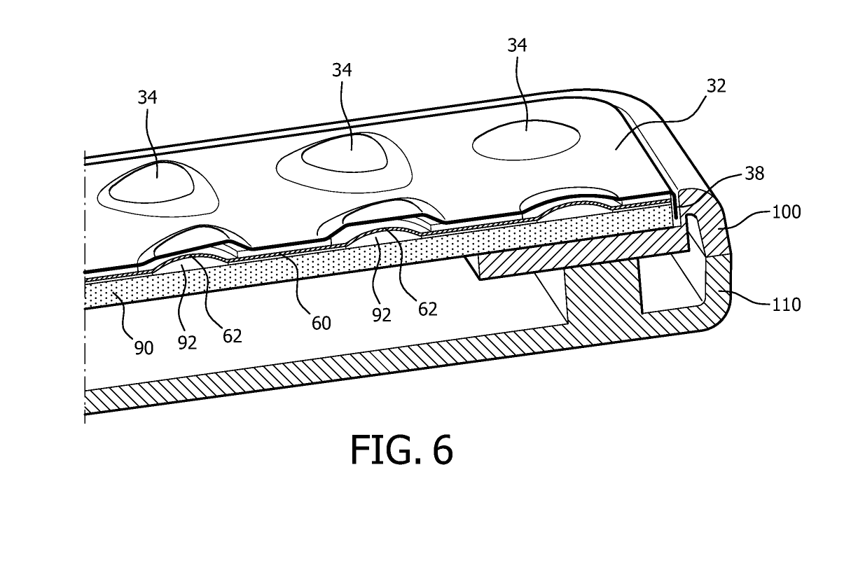

The assembly furthermore comprises an adhesive layer 40, a first spacing sheet 50, a dome sheet 60, in this case a poly dome sheet, and a second spacing sheet 70, as shown in FIG. 2. The first and the second spacing sheets may be polyester sheets and the adhesive layer may be acrylic based. At the positions corresponding to the key areas of the faceplate, the poly dome sheet comprises switch elements (e.g., dome switches) 62, which in use enter in contact with a corresponding contact point 92 on a PCB 90 (see FIG. 6). The adhesive layer 40, the first spacing sheet 50 and the second spacing 70 each comprise respective openings 42,52,72 at positions corresponding to the keys 32 of the faceplate 30 and the switch elements 62.

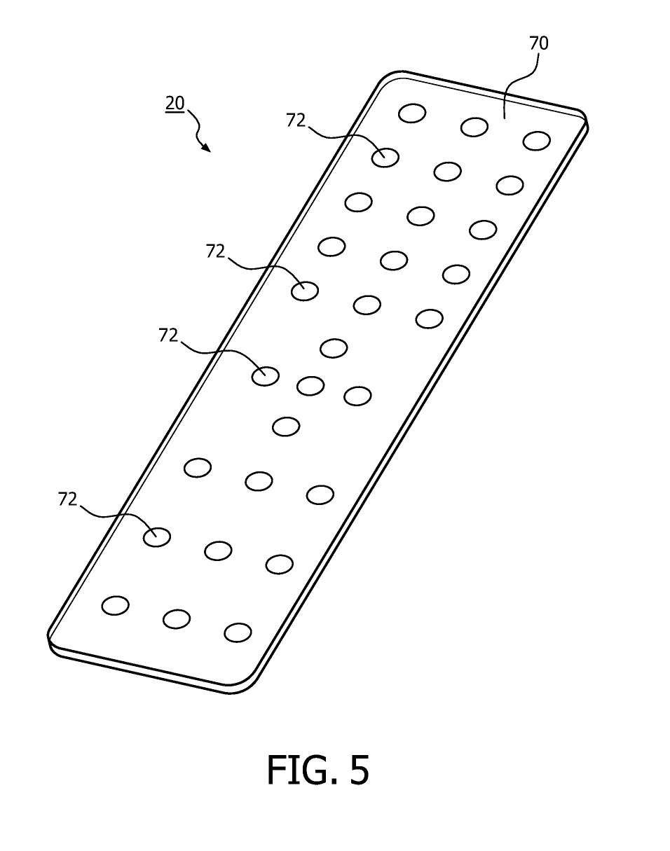

The assembly 20 is with its backside, i.e. the backside of the second spacing sheet 70, as shown in FIG. 5 attached to the remaining part 80 of the key pad device 10. This attachment may be by pasting the assembly 20 to the top housing 100 by means of adhesive at the assembly backside, more in particularly on the second spacing sheet 70.

The remaining part 80 of the keypad device 10 comprises, apart from the PCB, a top housing 100 and a bottom housing 110, as well as further components, which are not relevant for the present invention and will therefore not be discussed here. The space between the top housing 100 and bottom housing 110 is used for storing batteries.

The assembly 20 is mounted on top of a part of the top housing 100 of the keypad device 10, as shown in FIG. 6. The flap shaped edge 38 of the faceplate 30 is inserted in a recess 102 of the top housing 100, as shown in FIG. 6. When the user strikes a key, the deformable key area is pressed down and thereby presses down the corresponding dome switch 62, causing it to be in touch with the corresponding contact point 92 of the PCB 90. When the user releases the key area, the switch elements (e.g., dome switches) returns to its original position and thereby pushes back the corresponding key of the face plate in its initial position.

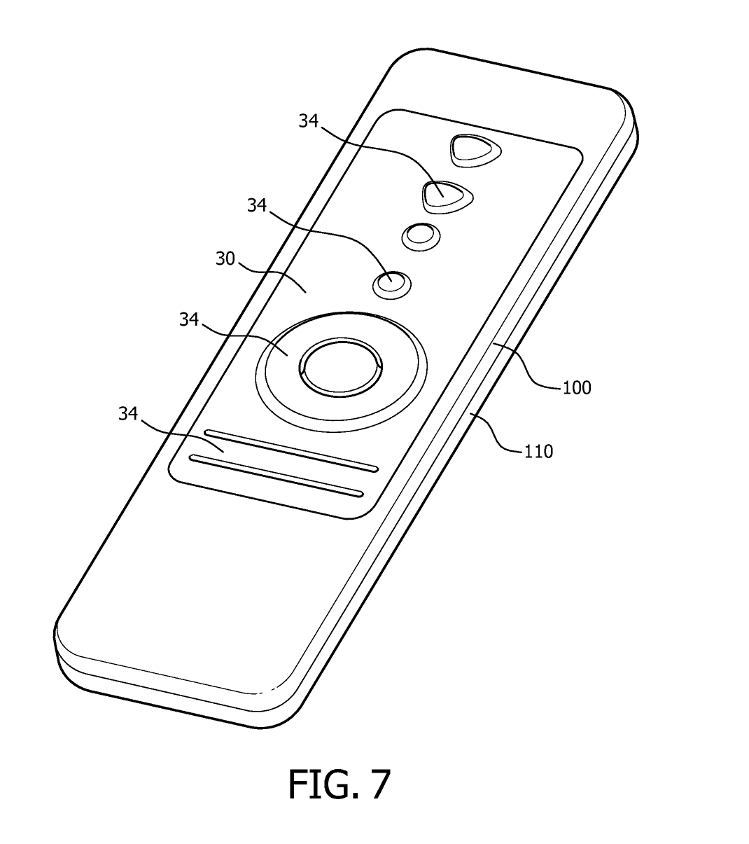

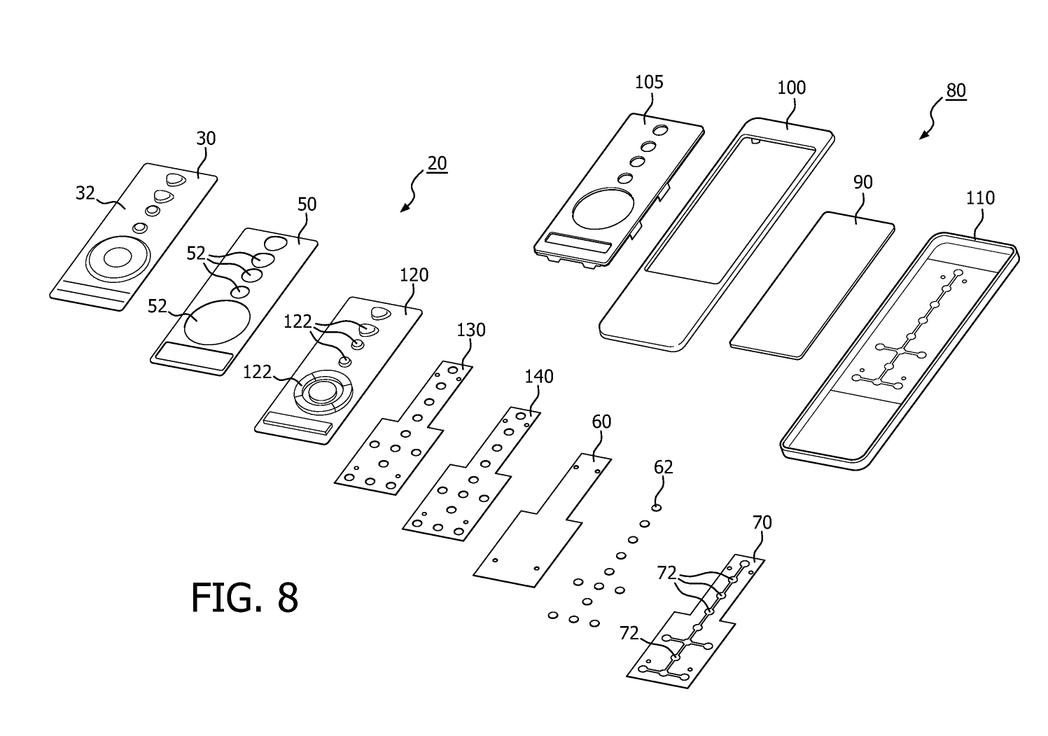

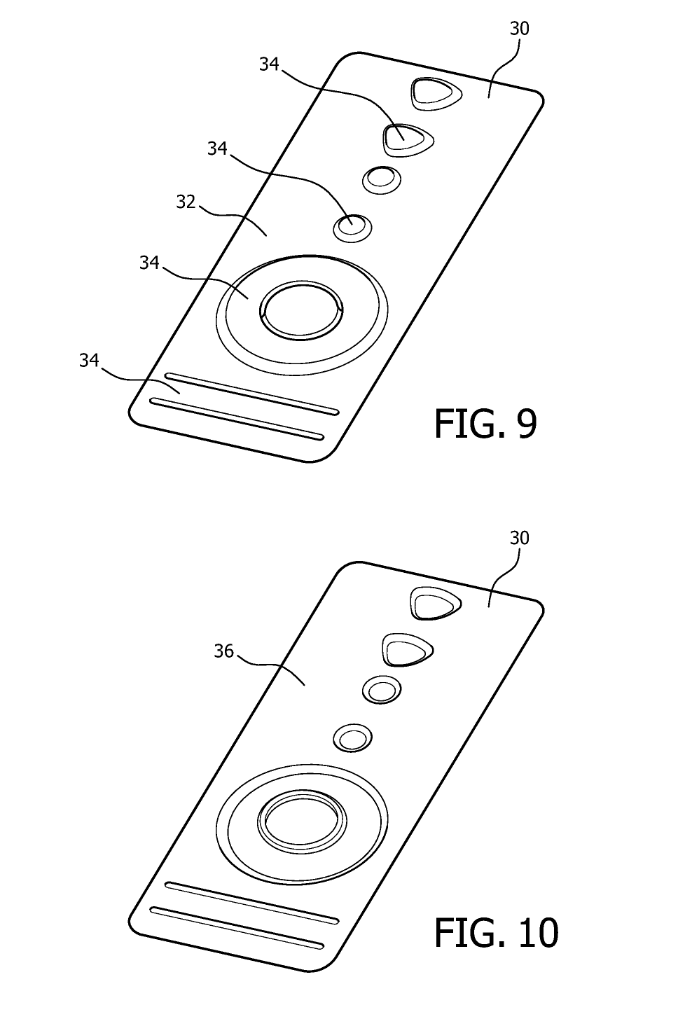

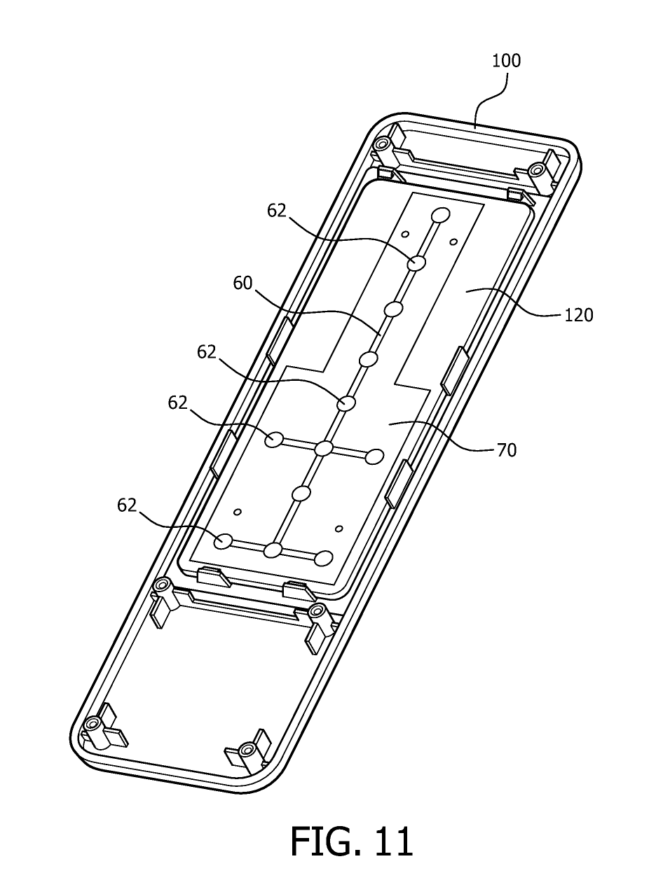

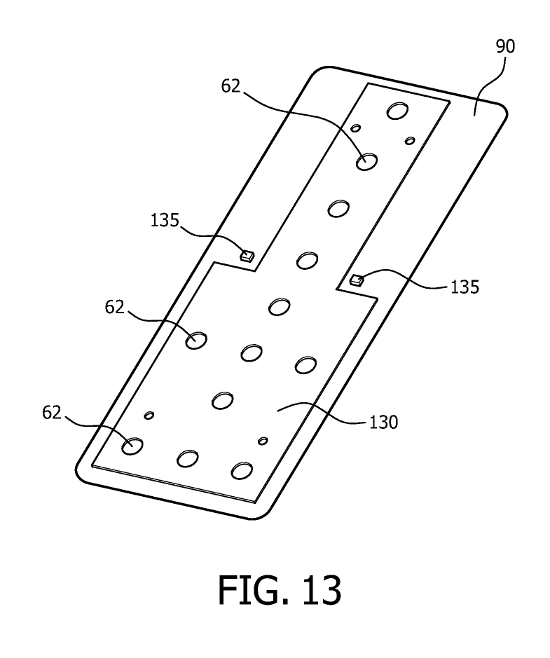

Now with reference to Figs. 7-13 a second embodiment of the key pad device is described. In this embodiment, the faceplate 30 is somewhat smaller than according to the first embodiment. Only a single row of keys is shown in the figures but of course there may be several key rows. The dome sheet 60 is a metal dome sheet, which is fitted on a plurality of metal switch elements (e.g., dome switches) 62 at the key positions. Instead of using a separate first spacing sheet 50 and adhesive layer 40, there is provided a first spacing sheet 50 with adhesive. A rubber keymat 120 is located between the faceplate 30 and the dome sheet 60. There are LEDs 135 used for lighting icons and graphics on the faceplate. The LEDs are placed either between the switch elements (e.g., dome switches) or at edges or slots of a light guide sheet 130, as shown in FIG. 13. The light guide sheet is attached to the metal dome sheet 60 by a light guide adhesive 140. In the second embodiment as shown in FIGS. 7-13 the light guide 130 is on top of the metal dome sheet 60. However, it can alternatively be below the space sheet, depending on the product design and the areas of the faceplate to be lighted. It may be a piece of plastic or a sheet. Apart from the top housing 100, there is a top housing cover 105. The faceplate 30 follows the profile of the top housing cover 105, which as a result supports the faceplate 30. The inner keys 122 of the rubber keymat 120 extend into the holes of the top housing cover 105 at the positions corresponding to the 3D keys 34 of the faceplate. The PCB 90 is locked on to the keymat 30 by screwing it to the top housing 100.

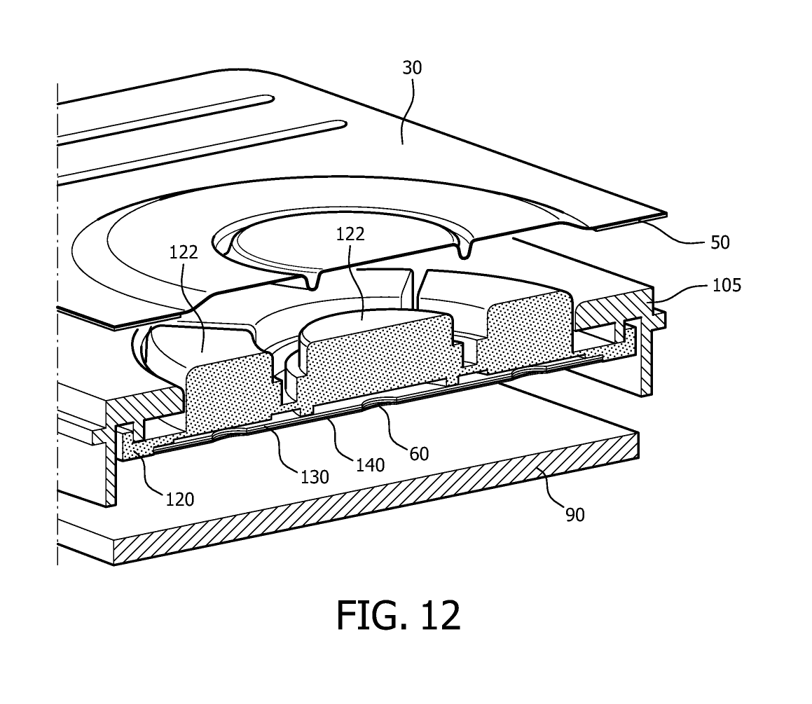

The assembly 20 consists of several subassemblies, which may be manufactured separately, before the assembly 20 and the remaining part 80 of the keypad device are mounted together, as shown in FIG. 12. These are the faceplate subassembly, which comprises the faceplate 30 and the first spacing sheet 50 adhered thereto and the rubber keymat subassembly. The rubber keymat subassembly at its turn comprises a top layer consisting of the rubber keymat 120 itself, a middle layer consisting of the light guide 130 and the light guide adhesive 140 and a lower layer, consisting of the metal dome sheet 60, the metal switch elements (e.g., dome switches) 62 and the adhesive spacing sheet 70. The top, middle and lower layers are first assembled separately and then mounted together to get the rubber keymat subassembly. Then this subassembly is attached to the remaining part 80 of the key pad device obtaining a “semi-finished” product. The faceplate subassembly is the final part to be assembled to the product before going through testing or final check. As explained, the faceplate can have different keys (i.e. size, shapes) and printing (i.e. graphics and colors). The semi-finished product can be assembled first before receiving an order of the final customer for the correct faceplate. The faceplate assembly (faceplate 30 and adhesive spacing layer 50) can be pasted to the semi finished product once available. This allows easy customization and variations to the faceplate.

While the invention has been illustrated and described in detail in the drawings and foregoing description, such illustration and description are to be considered illustrative or exemplary and not restrictive; the invention is not limited to the disclosed embodiments.

For example, instead of being part of a poly dome or metal dome sheet 60, the plurality of dome switches may alternatively be discrete rubber components being placed on top of the PCB 90. Such discrete rubber dome switches are sufficient for pushing back the corresponding key areas to their original position after a key press. However, the pressing feeling for the user is not so smooth as with the first and particularly the second embodiment.

Instead of being used for remote controls the design can alternatively be used for other keypad devices, such as (mobile) phones and calculators.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. Assembly for use in a keypad device, the assembly comprising:
a seamless faceplate comprising a plurality of key areas protruding outwardly from a remainder of the surface (32) of the faceplate, the key areas being of deformable material, the faceplate (30) forming the top surface of the keypad device when the assembly is attached to the remainder of the keypad device; and
a plurality of switch elements, below the faceplate, which at least partly correspond to the key areas, the switch elements being arranged to contact a corresponding contact point on a circuit arrangement as a result of force exerted by the corresponding key area on the switch element in response to a force on the corresponding key area being applied by a user, wherein after the user stops applying the force, the key area returns to its original position.

2. Assembly according to claim 1 wherein the plurality of switch elements comprises a plurality of dome switches below the faceplate and wherein the plurality of dome switches is arranged in a dome sheet.

3. Assembly according to claim 2 further comprising a first spacing sheet located between the faceplate and the dome sheet, wherein the first spacing sheet is preferably adhered to the faceplate.

4. Assembly according to claim 3 wherein first spacing sheet is adhered to the faceplate by means of an adhesive sheet.

5. Assembly according to claim 2 further comprising a second spacing sheet for separating the dome sheet and the circuit arrangement.

6. Assembly according to claim 1 wherein the faceplate is at least partially translucent or transparent.

7. Assembly according to claim 6 wherein there are printed graphics on the inner side of the faceplate.

8. Assembly according to claim 1 wherein at least one of the following parameters of the key areas of the faceplate is different between at least some of the key areas: size, shape or protrusion.

9. Assembly according to claim 2 wherein the dome sheet is a poly dome sheet or a metal dome sheet.

10. Assembly according to claim 1 further comprising at least one of the following: a color sheet, light guides or an electroluminescent sheet.

11. Assembly according to claim 1, wherein the faceplate at its edge has a flap shape.

12. Keypad device comprising the assembly according to claim 1 and comprising furthermore the circuit arrangement.

13. Keypad device according to claim 12 further comprising a top housing and a bottom housing, wherein a part of the top housing at least partially surrounds the edge of the faceplate.

14. Keypad device according to claim 12 further comprising a plurality of inner keys, each of the inner keys located between one of the key areas of the faceplate and one of the switch elements.

15. Keypad device according to claim 14 further comprising a top housing cover of which a part is located between the plurality of inner keys, wherein the inner side of the faceplate, which does not correspond to the key areas of the faceplate is supported by the top housing cover.

16. Assembly according to claim 2 wherein the dome switches are configured to return the corresponding key areas to their original position, when the corresponding dome switch returns to its original position after the user stops applying the force.

17. A method of manufacturing an assembly for use in a keypad device, the method comprising
manufacturing a first sub-assembly and a second sub-assembly, the first sub-assembly comprising a metal dome sheet with dome switches, the dome switches being arranged to contact a corresponding contact point on a circuit arrangement as a result of force on the dome switches, and the second sub-assembly comprising a seamless faceplate comprising a plurality of key areas protruding outwardly from a remainder of the surface of the faceplate, the key areas being of deformable material,
attaching the second sub-assembly on top of the first sub-assembly, with the dome switches corresponding at least partly to the key areas.
